(19) United States
(12) Patent Application Publication
(10) Pub. No.: US 2026/0043675 A1
(43) Pub. Date: Feb. 12, 2026

(54) METHOD FOR DETECTING CAPACITANCE BETWEEN AUTOMOTIVE INTERIOR COMPONENT AND HUMAN BODY, SENSING DEVICE WITH CHARGE RECEIVING MAPPING LAYER AND STEERING WHEEL WITH HAND-OFF DETECTION

(71) Applicant: AEW TECHNOLOGY GROUP CO., LTD., Langfang (CN)

(72) Inventors: Haitao ZHANG, Langfang (CN); Chunmei LI, Langfang (CN); Hui JING, Langfang (CN); Chang LIU, Langfang (CN)

(73) Assignee: AEW TECHNOLOGY GROUP CO., LTD., Langfang (CN)

(21) Appl. No.: 19/312,458

(22) Filed: Aug. 28, 2025

Related U.S. Application Data
(63) Continuation-in-part of application No. PCT/CN2025/086692, filed on Apr. 1, 2025.

(30) Foreign Application Priority Data
Aug. 8, 2024 (CN) 202411086147.7
Aug. 8, 2024 (CN) 202411086149.6

(51) Int. Cl. G01D 5/24; B60N 2/56

(52) U.S. Cl. CPC G01D 5/24; B60N 2/5685; B60N 2210/12

(57) ABSTRACT

Embodiments of the present disclosure provide a method for detecting a capacitance between an automotive interior component and a human body, including heating the automotive interior component through a metal wire in a heating period, acquiring a total human body occupancy capacitance through a metal wire in a sampling period, comparing magnitudes of the total human body occupancy capacitance and a capacitance threshold to obtain an occupancy situation of the automotive interior component, and repeatedly executing the above process.

### CROSS-REFERENCE TO RELATED APPLICATIONS

The present disclosure is a Continuation-in-part of the PCT international application with the filing No. PCT/CN2025/086692 filed on Apr. 1, 2025.

The present disclosure claims priority to Chinese Patent Application No. 2024110861496, filed on Aug. 8, 2024 with the Chinese Patent Office, and entitled “METHOD FOR DETECTING CAPACITANCE BETWEEN AUTOMOTIVE INTERIOR COMPONENT AND HUMAN BODY”; and
priority to Chinese Patent Application No. 2024110861477 filed on Aug. 8, 2024 with the Chinese Patent Office, and entitled “SENSING DEVICE WITH CHARGE RECEIVING MAPPING LAYER AND STEERING WHEEL WITH HAND-OFF DETECTION”, the entire contents of which are incorporated herein by reference.

### TECHNICAL FIELD

The present disclosure relates to the technical field of automobiles, and specifically to a method for detecting a capacitance between an automotive interior component and a human body, a sensing device with a charge receiving mapping layer and a steering wheel with hand-off detection.

### BACKGROUND

In designs of modern automobiles, there are growing demands for intelligent and humanized functions of automotive interior components. Accurate detection of occupancy of interior components (such as steering wheel and seats) by vehicle occupants is of important significance. Conventional detection methods for automotive interior component occupancy usually rely on simple mechanical switches or pressure sensors, but these methods have many restrictions. Mechanical switches are prone to wear over extended use, causing reduced detection reliability; and pressure sensors exhibit inadequate detection accuracy and response speed, and can hardly meet ever-increasing user demands.

An occupancy sensor includes a sheetlike substrate and a metal wire provided on the sheetlike substrate. With the development of technologies, a detection way based on capacitance principle emerges, namely, an occupancy situation is determined by a capacitance formed between the sensor metal wire built in the automotive interior component and a human body. As shown in FIG. 2, C1 in FIG. 2 is a sensing capacitance between the metal wire and the human body.

However, such existing capacitance detection solution still needs to be improved in sensitivity, and misjudgment or delayed response may occur in some complicated use scenarios, thus affecting user experience and intelligent functions of automobiles.

### SUMMARY

In view of the above defects or shortcomings in the prior art, embodiments of the present disclosure provide a method for detecting a capacitance between an automotive interior component and a human body, including steps as follows:
S100, setting an occupancy capacitance threshold, a sampling period and a heating period;
S200, heating the automotive interior component through a metal wire in the heating period, where a human body occupancy sensor is provided in the automotive interior component, and a sheetlike substrate and the metal wire provided on the sheetlike substrate are provided in the human body occupancy sensor;
S300, acquiring a total human body occupancy capacitance through the human body occupancy sensor in the sampling period, where a capacitance receiving layer having conductivity is further provided in the automotive interior component, and the total human body occupancy capacitance is obtained through sensing capacitances between the human body and the metal wire, between the human body and the capacitance receiving layer and between the metal wire and the capacitance receiving layer;
S400, comparing magnitudes of the total human body occupancy capacitance and the occupancy capacitance threshold, so as to obtain a comparison result, where the comparison result includes a first comparison result and a second comparison result, when the total human body occupancy capacitance is larger than or equal to the occupancy capacitance threshold, the first comparison result is obtained, and when the total human body occupancy capacitance is smaller than the occupancy capacitance threshold, the second comparison result is obtained, the first comparison result indicates that the automotive interior component is occupied, and the second comparison result indicates that the automotive interior component is unoccupied;
S500, executing step S200;
S600, updating the total human body occupancy capacitance, and executing steps S300-S400; and
S700, repeatedly executing steps S500-S600.

Optionally, the acquiring a total human body occupancy capacitance through the human body occupancy sensor in the sampling period includes following steps:
S310, obtaining a single-sampling total capacitance according to a first sensing capacitance, a second sensing capacitance, and a third sensing capacitance, where the first sensing capacitance is a sensing capacitance between the human body and the metal wire, the second sensing capacitance is a sensing capacitance between the human body and the capacitance receiving layer, and the third sensing capacitance is a sensing capacitance between the metal wire and the capacitance receiving layer; and
S320, obtaining the total human body occupancy capacitance through a capacitance mean strategy.

Optionally, the capacitance receiving layer is provided on a side of the metal wire away from the sheetlike substrate.

Optionally, the capacitance receiving layer is provided on either side of the metal filament, and the capacitance receiving layer has weak conductivity, so as to receive charges mapped by the metal filament and expand a sensing area.

Optionally, the sheetlike substrate is provided on either side of the metal filament, the sheetlike substrate is made from a non-conductive material, and the capacitance receiving layer is provided on a side of the metal filament away from the sheetlike substrate.

Optionally, a bonding layer is provided on a side of the metal filament away from the sheetlike substrate, the bonding layer is made from a conductive adhesive with weak conductivity, and the bonding layer is the capacitance receiving layer.

Optionally, a first adhesive layer is provided on the side of the metal filament away from the sheetlike substrate, and a covering layer is provided on a side of the first adhesive layer away from the metal filament, where the covering layer is a flexible sheet made from a micro conductive material, and the covering layer is the capacitance receiving layer.

Optionally, the metal filament is bonded onto the sheetlike substrate through a second adhesive layer, where the second adhesive layer adopts a conductive adhesive with weak conductivity, and the second adhesive layer is the capacitance receiving layer.

Optionally, the sheetlike substrate has weak electrical property, and the sheetlike substrate is used as the capacitance receiving layer.

Optionally, a skin is provided on the side of the metal filament away from the sheetlike substrate, where the skin is made from a micro conductive material, and the skin is the capacitance receiving layer.

Optionally, the micro conductive material is obtained by carburizing, printing, soaking in a conductive liquid, electroplating, or adding conductive fibers to woven fibers.

Optionally, a square resistance of the capacitance receiving layer is between 10³Ω and 10⁶Ω.

Optionally, the capacitance mean strategy includes following steps:
S321, setting a number of single samplings;
S322, acquiring a total capacitance sequence, where the total capacitance sequence includes a plurality of the single-sampling total capacitances, and a number of single-sampling total capacitances of the total capacitance sequence is the same as the number of the single samplings; and
S323, calculating an arithmetic mean of the total capacitance sequence, so as to obtain the total human body occupancy capacitance.

Optionally, the updating the total human body occupancy capacitance includes following steps:
S610, removing a first single-sampling total capacitance in the total capacitance sequence, and adding the single-sampling total capacitance obtained in a next sampling period to an end of the total capacitance sequence, so as to obtain an updated total capacitance sequence;
S620, calculating an arithmetic mean of the updated total capacitance sequence, so as to obtain a next total human body occupancy capacitance, as a first total occupancy capacitance; and
S630, updating the total human body occupancy capacitance in step S300 as the first total occupancy capacitance.

Optionally, a product of a sum of the sampling period and the heating period and the number of single samplings is smaller than a preset detection duration, to realize that the comparison result can be obtained at least once within the preset detection duration.

Optionally, a duration of the heating period is 2.5 times or more of that of the sampling period.

Optionally, the capacitance receiving layer has weak conductivity.

Optionally, the capacitance receiving layer has strong conductivity, and a strong dielectric layer is present between the capacitance receiving layer and the metal wire.

Embodiments of the present disclosure further provide a sensing device with a charge receiving mapping layer, including a cushion body, where the cushion body includes:
a functional layer, where the functional layer at least includes a metal filament and an insulating layer, and the metal filament is configured to heat and sense; and
an expansion layer, where the expansion layer is provided on either side of the metal filament, and the expansion layer has weak conductivity, so as to receive charges mapped by the metal filament, and expand a sensing area.

Optionally, a substrate is provided on a first surface of either side of the functional layer, where the substrate is made from a micro conductive material, and the substrate is the expansion layer.

Optionally, a substrate is provided on either side of the metal filament, where the substrate is made from a non-conductive material, and the expansion layer is provided on a side of the metal filament away from the substrate.

Optionally, a bonding layer is provided on the side of the metal filament away from the substrate, where the bonding layer is made from a conductive adhesive with weak conductivity, and the bonding layer is the expansion layer.

Optionally, a first adhesive layer is provided on the side of the metal filament away from the substrate, and a covering layer is provided on a side of the first adhesive layer away from the metal filament, where the covering layer is a flexible sheet made from a micro conductive material, and the covering layer is the expansion layer.

Optionally, the metal filament is bonded onto the substrate through a second adhesive layer, where the second adhesive layer adopts a conductive adhesive with weak conductivity, and the second adhesive layer is the expansion layer.

Optionally, a square resistance of the expansion layer is between 10³Ω and 10⁶Ω.

Optionally, the sensing device further includes a skin, where the skin is provided on a side of the metal filament away from the substrate, the skin is made from a micro conductive material, and the skin is the expansion layer.

Optionally, the micro conductive material is obtained by carburizing, printing, soaking in a conductive liquid, electroplating, or adding conductive fibers to woven fibers.

Embodiments of the present disclosure further provide a steering wheel with hand-off detection, where the steering wheel with hand-off detection includes a steering wheel body, and a surface of the steering wheel body is provided with the sensing device with a charge receiving mapping layer mentioned in the above.

To sum up, embodiments of the present disclosure provide a method for detecting a capacitance between an automotive interior component and a human body, including heating the automotive interior component through the metal wire in the heating period, acquiring the total human body occupancy capacitance through the human body occupancy sensor having the metal wire in the sampling period, comparing magnitudes of the total human body occupancy capacitance and the occupancy capacitance threshold to obtain an occupancy situation of the automotive interior component, and repeatedly executing the above process, to realize a heating function and a capacitance detection function in a time-division multiplexing manner. In addition, by adding the capacitance receiving layer having conductivity in the automotive interior component in the present disclosure, the sensing area is increased, that is, the total human body occupancy capacitance is increased, and the sensitivity of capacitance detection is improved.

Embodiments of the present disclosure provide a sensing device with a charge receiving mapping layer and a steering wheel with hand-off detection, including: a functional layer, where the functional layer at least includes a metal filament and an insulating layer, and the metal filament is configured to heat and sense; and an expansion layer, provided on either side of the metal filament, where the expansion layer has weak conductivity, so as to receive charges mapped by the metal filament, and expand a sensing area.

Compared with the prior art, beneficial effects of the present disclosure lie in: the sensing device with a charge receiving mapping layer provided in the present disclosure can be provided on an automotive interior component such as automotive seat or steering wheel, configured to sense information such as occupancy of a seat by a human body or hand grasping the steering wheel through capacitance changes, the expansion layer having weak conductivity is provide above or below the metal filament, to realize capacitance generation between the metal filament and the human body, between the metal filament and the expansion layer, and between the expansion layer and the human body, so as to increase the sensing capacitance of multi-frequency capacitance detection, improve sensitivity of multi-frequency capacitance detection occupancy technology, and improve accuracy of determination.

### BRIEF DESCRIPTION OF THE DRAWINGS

In order to more clearly illustrate technical solutions of embodiments of the present disclosure, drawings which need to be used in the embodiments will be briefly introduced below. It should be understood that the drawings merely show some embodiments of the present disclosure, and thus should not be construed as limitation to the scope. Those ordinarily skilled in the art still could obtain other relevant drawings according to these drawings, without using any inventive efforts.

FIG. 1 is a flowchart of a method for detecting a capacitance between an automotive interior component and a human body provided by embodiments of the present disclosure;

FIG. 2 is a structural schematic view of capacitance detection when an automotive interior component is an automotive seat, without a capacitance receiving layer, in a current solution;

FIG. 3 is a structural schematic view of capacitance detection when an automotive interior component is an automotive seat, and a capacitance receiving layer is disposed on a metal wire provided by an embodiment of the present disclosure;

FIG. 4 is a structural schematic view of an occupancy sensor and a capacitance receiving layer provided by an embodiment of the present disclosure;

FIG. 5 is a structural schematic view of capacitance detection when an automotive interior component is an automotive seat, and a sheetlike substrate is a capacitance receiving layer provided by an embodiment of the present disclosure;

FIG. 6 is a structural schematic view of a novel sensor provided by an embodiment of the present disclosure;

FIG. 7 is a schematic view of layout of a metal wire provided by an embodiment of the present disclosure;

FIG. 8 is a schematic view of layout of a metal wire and a capacitance receiving layer provided by an embodiment of the present disclosure;

FIG. 9 is a circuit schematic view after adding a capacitance receiving layer provided by an embodiment of the present disclosure;

FIG. 10 is an equivalent circuit diagram of FIG. 9;

FIG. 11 is an exploded structural schematic view when an automotive interior component is a steering wheel, and a sheetlike substrate acts as a capacitance receiving layer;

FIG. 12 is an exploded structural schematic view when an automotive interior component is a steering wheel, a sheetlike substrate is made from a non-conductive material, and a capacitance receiving layer is added;

FIG. 13 is a structural schematic view of a sensing device (an expansion layer is a substrate) with a charge receiving mapping layer provided by an embodiment of the present disclosure;

FIG. 14 is a structural schematic view of a sensing device (an expansion layer is a bonding layer) with a charge receiving mapping layer provided by an embodiment of the present disclosure;

FIG. 15 is a structural schematic view of a sensing device (an expansion layer is a second adhesive layer) with a charge receiving mapping layer provided by an embodiment of the present disclosure;

FIG. 16 is a structural schematic diagram of sewing a metal filament onto a substrate provided by an embodiment of the present disclosure;

FIG. 17 is a structural schematic diagram of adhering a metal filament onto a substrate provided by an embodiment of the present disclosure;

FIG. 18 is a structural schematic view of applying a sensing device with a charge receiving mapping layer provided by an embodiment of the present disclosure to a seat scenario (a substrate is made from a non-conductive material);

FIG. 19 is a structural schematic view of applying a sensing device with a charge receiving mapping layer provided by an embodiment of the present disclosure to a seat scenario (a substrate is an expansion layer);

FIG. 20 is a sectional structural schematic view of a steering wheel with hand-off detection (an expansion layer is a substrate) provided by an embodiment of the present disclosure;

FIG. 21 is a sectional structural schematic view of a steering wheel with hand-off detection (an expansion layer is a skin) provided by an embodiment of the present disclosure;

FIG. 22 is a sectional structural schematic view of a steering wheel with hand-off detection (an expansion layer is a substrate and a third adhesive layer and a fourth adhesive layer are presented) provided by an embodiment of the present disclosure; and

FIG. 23 is a sectional structural schematic view of a steering wheel with hand-off detection (an expansion layer is a bonding layer) provided by an embodiment of the present disclosure.

Text labels in the drawings represent: 1. automotive interior component; 2. occupancy sensor; 21. sheetlike substrate (substrate); 22. metal wire (metal filament); 3. upholstery; 4. capacitance receiving layer (expansion layer); 5. novel sensor; 6. wire harness; 31. covering layer; 32. first adhesive layer; 7. skin; 33. third adhesive layer; 34. fourth adhesive layer; 8. bonding layer; 9. armature; 10. first foam layer; 11. second foam layer.

### DETAILED DESCRIPTION OF EMBODIMENTS

The present disclosure is further described in detail below with reference to drawings and embodiments. It can be understood that the embodiments described herein are merely used for explaining relevant application, rather than limiting this application. Besides, it should also be noted that in order to facilitate the description, only parts related to the application are shown in the drawings.

It should be noted that the embodiments in the present disclosure and features in the embodiments can be combined with each other without conflict. The present disclosure will be described in detail below with reference to the drawings and in combination with embodiments.

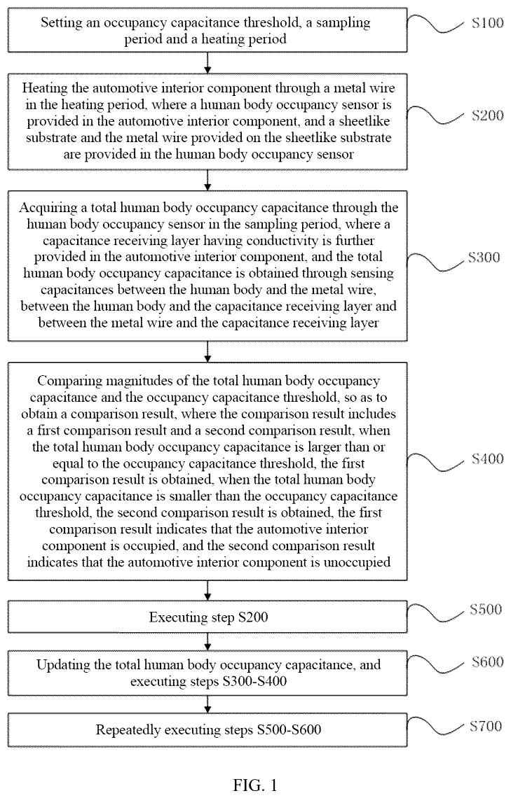

Regarding the technical problems mentioned in the Background, embodiments of the present disclosure provide a method for detecting a capacitance between an automotive interior component and a human body, as shown in FIG. 1, including steps as follows.
S100, setting an occupancy capacitance threshold, a sampling period and a heating period.

Optionally, a duration of the heating period is 2.5 times or more of that of the sampling period, for example, the heating period is 200 ms, and the sampling period is 20 ms, totaling 0.22 seconds.
S200, heating an automotive interior component 1 through a metal wire 22 in the heating period, where a human body occupancy sensor 2 is provided in the automotive interior component 1, and a sheetlike substrate 21 and the metal wire 22 provided on the sheetlike substrate 21 are provided in the human body occupancy sensor 2.

Herein, the automotive interior component 1 may be an automotive seat, a steering wheel, or other interior components having functions of heating and occupancy detection. A temperature sensor is further provided in the automotive interior component 1, and is configured to detect a temperature of the automotive interior component 1.
S300, acquiring a total human body occupancy capacitance through the human body occupancy sensor 2 in the sampling period, where a capacitance receiving layer 4 having conductivity is further provided in the automotive interior component 1, and the total human body occupancy capacitance is obtained through sensing capacitances between the human body and the metal wire 22, between the human body and the capacitance receiving layer 4 and between the metal wire 22 and the capacitance receiving layer 4, including steps as follows:
S310, obtaining a single-sampling total capacitance according to a first sensing capacitance, a second sensing capacitance, and a third sensing capacitance, where the first sensing capacitance is a sensing capacitance between the human body and the metal wire 22, the second sensing capacitance is a sensing capacitance between the human body and the capacitance receiving layer 4, and the third sensing capacitance is a sensing capacitance between the metal wire 22 and the capacitance receiving layer 4, including steps as follows:
S311, acquiring the first sensing capacitance between the human body and the metal wire 22.

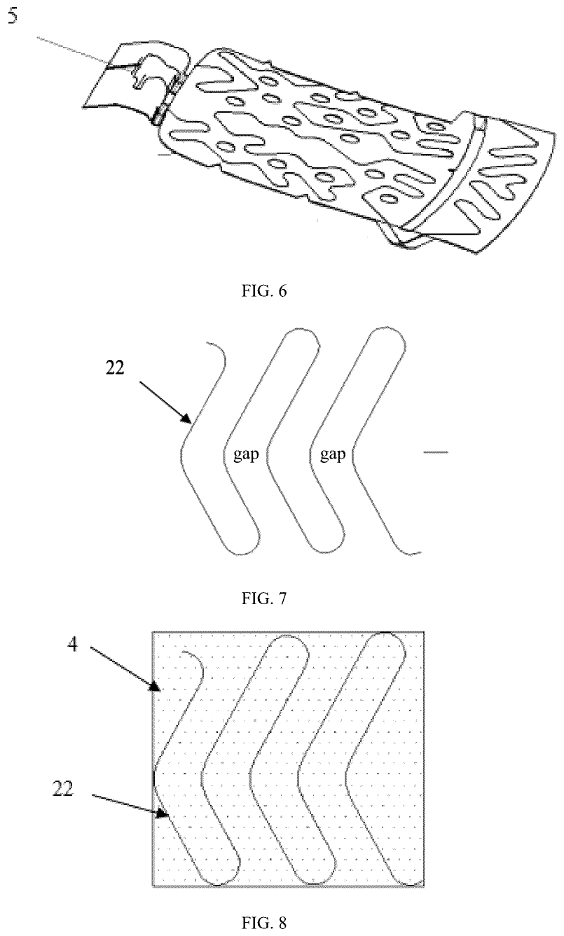

Herein, an outer layer of the metal wire 22 is enamel-insulated, and an outermost layer can be further provided with insulation protection. The metal wire 22 can be sewn onto the sheetlike substrate 21. Due to limitations of an embroidery process, a spacing must be kept between the metal wire 22, so as to form a relatively loose wiring form. As shown in FIG. 7, an effective sensing area is relatively small due to the wiring spacing.

Assuming that the sensing area between the occupancy sensor 2 and the human body is S, an upholstery 3 of the automotive interior component 1 has a thickness of d, and a dielectric constant is e, then the sensing capacitance is obtained through a formula as follows:

C=εS/4πkd∝S/d Formula (2).

Apparently, the capacitance C is proportional to the sensing area S. As the metal wire 22 has a relatively small surface area and the wiring is relatively loose due to process constraints, the effective sensing area(S) is very small, resulting in that the sensing capacitance is only on the order of picofarads (pF), typically around 50 pF.
S312, acquiring the second sensing capacitance between the human body and the capacitance receiving layer 4.

Optionally, the capacitance receiving layer 4 is provided on a side of the metal wire 22 away from the sheetlike substrate 21.

Optionally, the capacitance receiving layer 4 is provided on either side of the metal wire 22, and the capacitance receiving layer 4 has weak conductivity, so as to receive charges mapped by the metal wire 1 and expand the sensing area.

A working principle of providing the capacitance receiving layer 4 can be seen according to a capacitance formula C=εS/4πkd.

In the capacitance formula, meanings of various parameters are as follows: C represents a capacitance of a capacitor, ε represents a dielectric constant of a dielectric, and different dielectrics, such as air, plastics, and ceramics, have different dielectric constants, where the dielectric constant of air is close to 1, while some specific ceramic materials may have a relatively large dielectric constant, S represents a direct facing area of two capacitor plates, d represents a distance between two capacitor plates, where the smaller the distance, the larger the capacitance, and k is an electrostatic force constant, with a value of about 9.0×10⁹ N·m²/C².

It can be seen from the above capacitance formula that as a distance between the metal wire 22 and the capacitance receiving layer 4 is very small, charges of the metal wire 22 are projected to the capacitance receiving layer 4 with almost no loss. When the capacitance receiving layer 4 is provided, the sensing area S is increased from an initial surface area of the metal wire 22 to the surface area of the metal wire 22 plus a surface area of the capacitance receiving layer 4, thus effectively increasing the sensing capacitance.

Optionally, an insulating layer can be further provided on the surface of the metal wire 22, and the insulating layer enables the metal wire 22 to be insulated from other structures and will not leak electricity. In the present embodiment, the insulating layer covers the surface of the metal wire 22. Optionally, the insulating layer may be an insulating varnish coated on the surface of the metal wire 22.

In addition, although the metal wire 22 is provided with the insulating layer thereon, the insulating layer may be undesirably damaged during processing and use, and electricity may conduct between the metal wire 22 and the capacitance receiving layer 4, so that electricity is conducted through the damaged metal wire 22, causing short circuit hazard. Since the capacitance receiving layer 4 is weakly conductive and has a large square resistance, even if the insulating layer is damaged, a current across the metal wire 22 at a damaged portion will also be very small, and a heat generation amount will be very small, which can prevent occurrence of short circuit hazard when the insulating layer is damaged and occurrence of burning the sensing device.

Optionally, the sheetlike substrate 21 is provided on either side of the metal wire 22, the sheetlike substrate 21 is made from a non-conductive material, and the capacitance receiving layer 4 is provided on a side of the metal wire 22 away from the sheetlike substrate 21.

Optionally, a bonding layer 8 is provided on a side of the metal wire 22 away from the sheetlike substrate 21, the bonding layer 8 is made from a conductive adhesive with weak conductivity, and the bonding layer 8 is the capacitance receiving layer 4. Optionally, the bonding layer 8 is a conductive adhesive with weak conductivity. During installation, release paper coated with the conductive adhesive with weak conductivity is selected, and after the release paper is peeled off, the conductive adhesive with weak conductivity is bonded to the side of the metal wire 22 away from the substrate 21.

Optionally, a first adhesive layer 32 is provided on the side of the metal wire 22 away from the sheetlike substrate 21, and a covering layer 31 is provided on a side of the first adhesive layer 32 away from the metal wire 22. The covering layer 31 is a flexible sheet made from a micro conductive material, and the covering layer 31 is the capacitance receiving layer 4. Optionally, the flexible sheet of the covering layer 31 is foam or fabric made from a micro conductive material.

Optionally, the metal wire 22 is bonded onto the sheetlike substrate 21 through a second adhesive layer, where the second adhesive layer adopts a conductive adhesive with weak conductivity, and the second adhesive layer is the capacitance receiving layer 4.

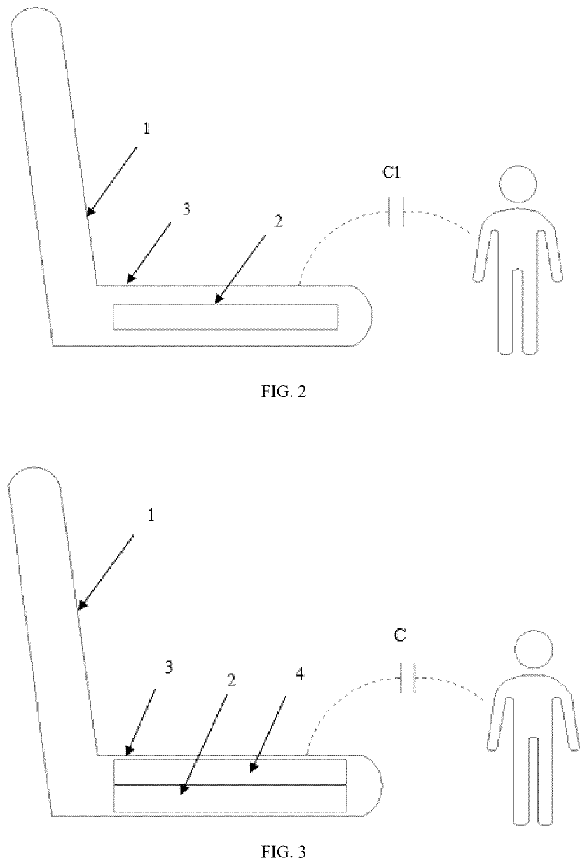

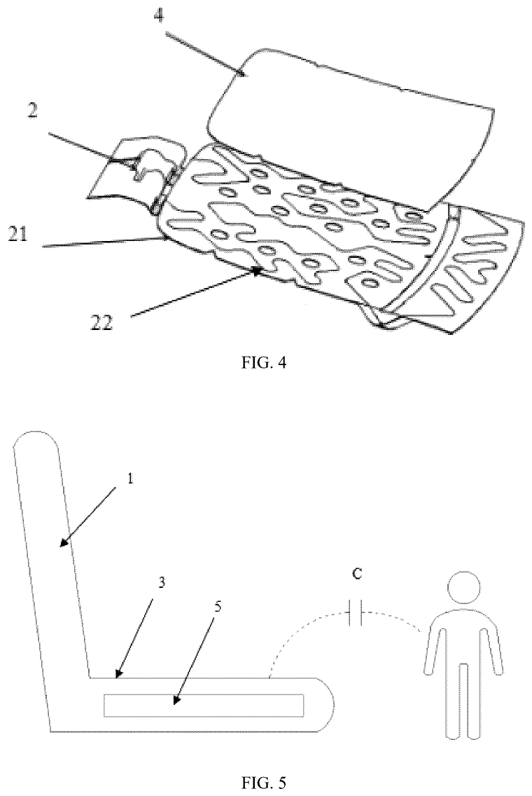

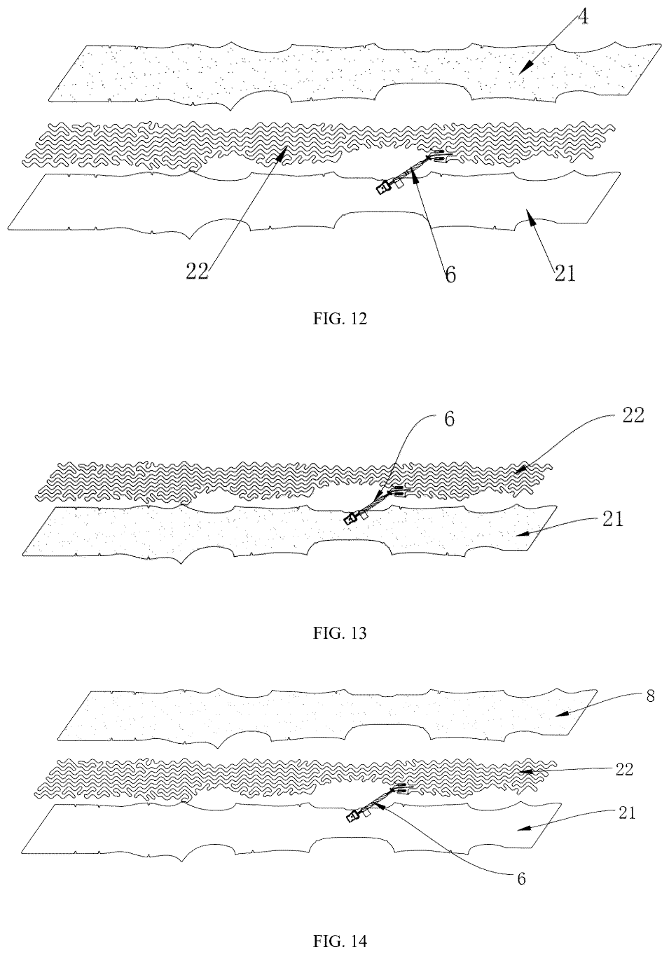

Referring to what are shown in FIG. 3, FIG. 4, FIG. 8 and FIG. 12, the capacitance receiving layer 4 may be metal cloth, micro conductive fiber cloth or any highly durable flexible material doped with a micro conductive composition. Although the capacitance receiving layer 4 and the occupancy sensor 2 are two independent layers, the two are closely attached, with spacing of approximately 0. FIG. 12 is an exploded view, while the capacitance receiving layer 4 and the metal wire 22 in fact are closely attached. The metal wire 22 is connected to a control module through a wire harness. The control module stores a program configured to execute a method for detecting a capacitance between the automotive interior component and the human body provided by embodiments of the present disclosure.

Optionally, the sheetlike substrate 21 has weak electrical property, and the sheetlike substrate 21 is used as the capacitance receiving layer 4.

Optionally, a skin 7 is provided on the side of the metal wire 22 away from the sheetlike substrate 21, where the skin 7 is made from a micro conductive material, and the skin 7 is the capacitance receiving layer 4.

Optionally, the micro conductive material is obtained by carburizing, printing, soaking in a conductive liquid, electroplating, or adding conductive fibers to woven fibers.

Optionally, the square resistance of the capacitance receiving layer 4 is between 10³Ω and 10⁶Ω.

Referring to what are shown in FIG. 5, FIG. 6, FIG. 8 and FIG. 11, the capacitance receiving layer 4 is used as the sheetlike substrate 21 of the occupancy sensor 2, and the metal wire 22 is directly embroidered on the capacitance receiving layer 4, in this way, the capacitance receiving layer 4 and the occupancy sensor 2 are integrated into one, which is called as a novel sensor 5 with receiving and expanding functions. The sheetlike substrate 21 of the novel sensor 5 may be micro conductive fiber cloth or any highly durable flexible material doped with a micro conductive composition. The capacitance receiving layer 4 is used as the sheetlike substrate 21, and belongs to the same layer as the occupancy sensor 2, with an inter-layer spacing of 0. Analyzed from the sensing area, the capacitance receiving layer 4 fills an entire planar space with sensing charges, equivalent to eliminating gaps of the metal wire 22, thereby greatly increasing the sensing area.
S313, acquiring the third sensing capacitance between the metal wire 22 and the capacitance receiving layer 4.

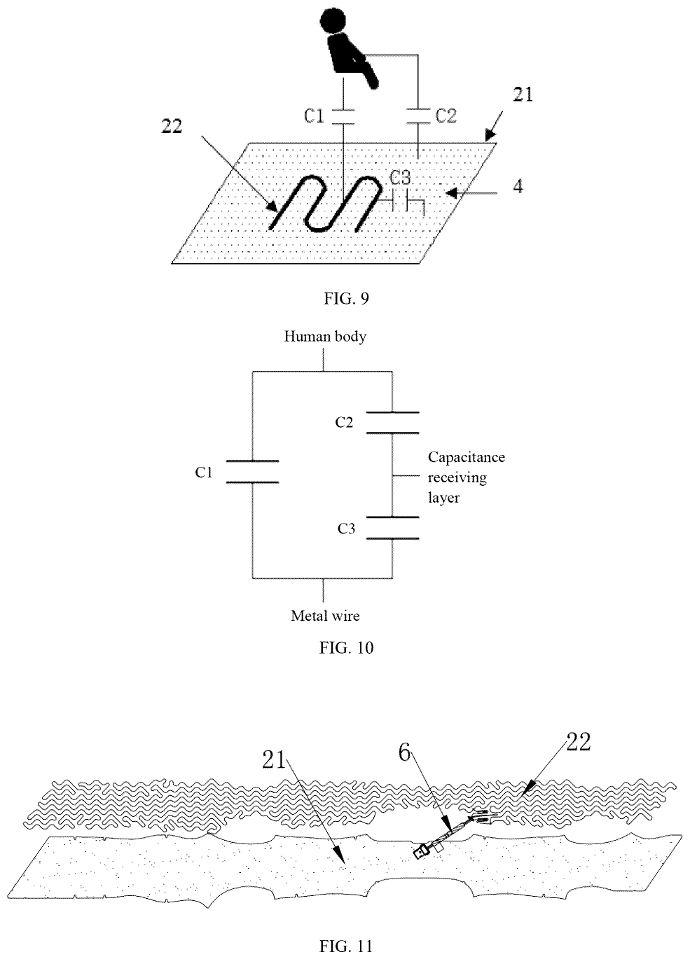

As shown in FIG. 9 and FIG. 10, C2 represents the second sensing capacitance, C3 represents the third sensing capacitance, and C1 represents the first sensing capacitance. A distance between the capacitance receiving layer 4 and the metal wire 22 is quite small and can almost be ignored, and thus, charge mapping loss between the two is quite small. According to Formula (2), it can be seen that the sensing capacitance is inversely proportional to the distance between the two, thus ensuring sensing performance of the capacitance receiving layer 4.
S314, inputting the first sensing capacitance, the second sensing capacitance, and the third sensing capacitance into a total-capacitance calculation function to obtain the total capacitance.

Herein, an equivalent circuit of embodiments of the present disclosure is as shown in FIG. 9, and the capacitance calculation function is shown as follows:

C=C1+C2*C3/(C2+C3) Formula (1)

Herein, C represents the total capacitance, C1 represents the first sensing capacitance, C2 represents the second sensing capacitance, and C3 represents the third sensing capacitance.

Optionally, the single-sampling total capacitance can be directly acquired without steps S311-S314, and the first sensing capacitance, the second sensing capacitance and the third sensing capacitance can also be acquired respectively through steps S311-S314, and then the single-sampling total capacitance is obtained through calculation.

Herein, in addition to serving as a sensing electrode, the metal wire 22 can also serve as a heater, realizing both functions of capacitance detection and conventional heating of the automotive interior component 1.
S320, obtaining the total human body occupancy capacitance through a capacitance mean strategy, including steps as follows:
S321, setting the number of single samplings; and
S322, acquiring a total capacitance sequence, where the total capacitance sequence includes a plurality of single-sampling total capacitances, and the number of total capacitances of the total capacitance sequence is the same as the number of the single samplings.

Optionally, the number of the single samplings is 4, and the capacitance sequence is [C1, C2, C3, C4], where C1 represents the single-sampling total capacitance obtained through a first sampling, C2 represents the single-sampling total capacitance obtained through a second sampling, C3 represents the single-sampling total capacitance obtained through a third sampling, and C4 represents the single-sampling total capacitance obtained through a fourth sampling.
S344, calculating an arithmetic mean of the total capacitance sequence, so as to obtain the total human body occupancy capacitance.

Compared with the prior art, the second sensing capacitance and the third sensing capacitance are added in the embodiments of the present disclosure, according to Formula (1), a value of the total capacitance is larger than the first sensing capacitance, and preferably, the capacitance receiving layer 4 is made from a quite compact flexible material, similar to a metal flat plate, and has a much larger sensing area than the metal wire 22 compared with a sparse wiring manner of the metal wire 22; therefore, the second sensing capacitance is much larger than the first sensing capacitance. In addition, the spacing between the capacitance receiving layer 4 and the metal wire 22 is approximately 0, and thus the third sensing capacitance is much larger than the first sensing capacitance.
S400, comparing magnitudes of the total human body occupancy capacitance and the occupancy capacitance threshold, so as to obtain a comparison result, where the comparison result includes a first comparison result and a second comparison result, when the total human body occupancy capacitance is larger than or equal to the occupancy capacitance threshold, the first comparison result is obtained, when the total human body occupancy capacitance is smaller than the occupancy capacitance threshold, the second comparison result is obtained, the first comparison result indicates that the automotive interior component 1 is occupied, and the second comparison result indicates that the automotive interior component 1 is unoccupied.
S500, executing step S200, that is, after performing the capacitance detection, heating the automotive interior component 1 again.
S600, updating the total human body occupancy capacitance, and executing steps S300-S400, including steps as follows:
S610, removing a first single-sampling total capacitance in the total capacitance sequence, and adding the single-sampling total capacitance obtained in a next sampling period to an end of the total capacitance sequence, so as to obtain an updated total capacitance sequence. Taking the number of single samplings being 4 as an example, the updated total capacitance sequence is [C2, C3, C4, C5], where C5 represents the single-sampling total capacitance obtained through a fifth sampling;
S620, calculating an arithmetic mean of the updated total capacitance sequence, so as to obtain a next total human body occupancy capacitance, as a first total occupancy capacitance; and
S630, updating the total human body occupancy capacitance in step S360 as the first total occupancy capacitance.
S700, repeatedly executing steps S500-S600; except for a first capacitance detection, the capacitance detection needs to be performed after the total human body occupancy capacitance is updated for each subsequent capacitance detection. In the present disclosure, the capacitance detection and heating functions are alternately executed in a time-division multiplexing manner, and the sensing capacitance is increased by adding the capacitance receiving layer 4, thus improving detection sensitivity.

Taking that the metal wire 22 is 5.8 meters, the wiring spacing of the metal wire 22 is 10 mm, the capacitance receiving layer 4 is micro conductive cloth of 0.7 meters×0.4 meters, and the upholstery 3 is made from leather, with a thickness of 4 mm as an example for test, test data without the capacitance receiving layer 4 is listed in Table 1, and test data when adding the capacitance receiving layer 4 is listed in Table 2.

TABLE 1

| | | | | Total |
|---|---|---|---|---|
| Current Solution | C1 | C2 | C3 | Capacitance |
| Without Capacitance | 52 pf | — | — | 52 pf |
| Receiving Layer | | | | |

TABLE 2

| Solution with Addition of | | | | |
|---|---|---|---|---|
| Capacitance Receiving | | | | Total |
| Layer | C1 | C2 | C3 | Capacitance |
| Providing Capacitance | 11 pf | 115 pf | 214 pf | 86 pf |
| Receiving Layer on Metal | | | | |
| Wire | | | | |
| Sheetlike Substrate as | 20 pf | 103 pf | 220 pf | 90 pf |
| Capacitance Receiving | | | | |
| Layer | | | | |

It can be seen from comparison between Table 1 and Table 2 that, the solution in which the capacitance receiving layer 4 is provided on the metal wire 22 has the total capacitance increased by 65% compared with the current solution, and the solution in which the sheetlike substrate 21 is used as the capacitance receiving layer 4 has the total capacitance increased by 73% compared with the current solution.

Optionally, a product of a sum of the sampling period and the heating period and the number of single samplings is smaller than a preset detection duration, realizing that the comparison result can be obtained at least once within the preset detection duration.

Herein, optionally, the preset detection duration may be 1 s or 2 s. Calculated in the heating period of 200 ms and the sampling period of 20 ms, totaling 0.22 seconds, four periods of heating and capacitance detection can be executed within 1 s or 2 s, and a human body occupancy state can be identified within 1 s or 2 s.

Optionally, the capacitance receiving layer 4 has weak conductivity.

Herein, in order to avoid electricity leakage, the metal wire 22 is covered with the insulating layer outside. However, in the embroidering process, the insulating layer may be damaged by an embroidery machine or other reasons, in which case, if the capacitance receiving layer 4 having strong conductivity is used, short circuit hazard may occur, and heat generation is severe, causing burning of the interior component. When a material with weak conductivity is used, since it has very large resistance, ranging from 10³Ω to 10⁶Ω, a resistance value is large, a current is very small, and a heat generation amount is also very small, thus improving stress resistance of the human body occupancy sensor, and reducing risks of product damage.

Optionally, the capacitance receiving layer 4 has strong conductivity, and there is a strong dielectric layer between the capacitance receiving layer 4 and the metal wire 22.

Herein, when the capacitance receiving layer 4 has strong conductivity, sensitivity of the occupancy sensor 2 is higher. However, when the insulating layer is damaged, the metal wire 22 is easily short-circuited to the capacitance receiving layer 4, and thus the safety is low. The conductivity of the capacitance receiving layer 4 needs to be selected according to actual needs.

The above description is merely for preferred embodiments of the present disclosure and illustration of the technical principle used. It should be understood by those skilled in the art that the scope of application involved in the present disclosure is not limited to the technical solutions constituted by specific combinations of the above technical features, and at the same time, also covers other technical solutions formed by any combination of the above technical features or equivalent features, without departing from the inventive concept, for example, technical solutions formed by mutual substitution between the above features and technical features having similar functions disclosed in the present disclosure (but not limited thereto).

Embodiments of the present disclosure further provide a sensing device with a charge receiving mapping layer, including:
a functional layer, where the functional layer at least includes a metal filament 22 and an insulating layer, and the metal filament 22 is configured to heat and sense. The metal filament 22 mentioned herein is equivalent to the above-mentioned metal wire 22.

Optionally, the insulating layer insulates the metal filament 22 from other structures, and will not leak electricity. In the present embodiment, the insulating layer covers a surface of the metal filament 22. Optionally, the insulating layer may be an insulating varnish coated on the surface of the metal filament 22.

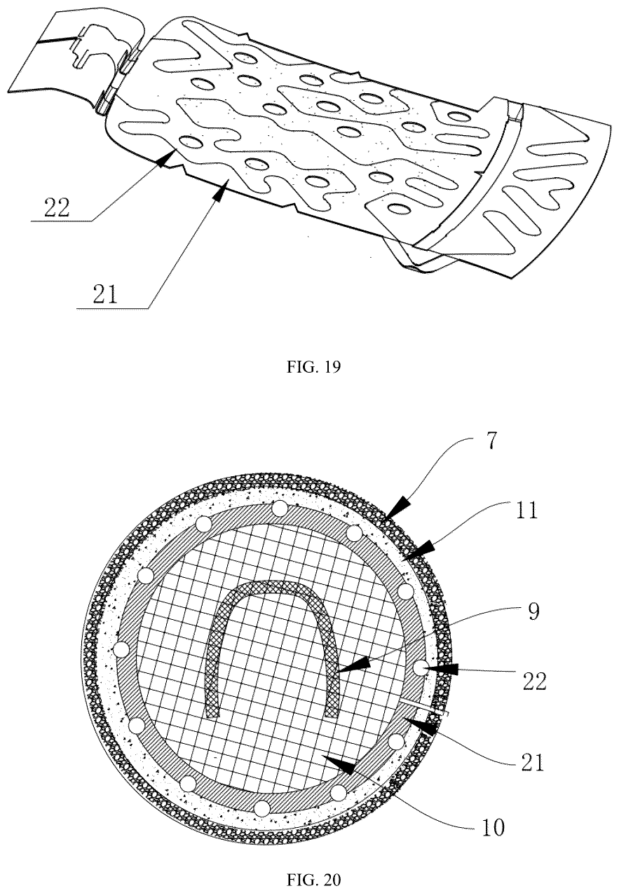

Optionally, with reference to what are shown in FIG. 13, FIG. 18 and FIG. 19, the functional layer is a cushion body for the sensing device to function. In multi-frequency capacitance detection occupancy technology, the metal filament 22 serves both as a heating element to provide a heating function and as a sensing element to provide a sensing function. When the metal filament 22 provides the sensing function, as the surface area of the metal filament 22 is small, the sensing sensitivity of this technology is not high, and technical improvements are made on this technology.

The functional layer is formed by coiling the metal filament 22, an outer layer of the metal filament 22 has the insulating layer, and the functional layer is of an elongated layered structure obtained by coiling the metal filament 22.

Optionally, the metal filament 22 is connected to a wire harness 6, and the wire harness 6 is configured to be plugged into a control module of the sensing device.

An expansion layer 4, where the expansion layer 4 is provided on either side of the metal filament 22, and the expansion layer 8 has weak conductivity, so as to receive charges mapped by the metal filament 22, and expand the sensing area. The expansion layer 4 mentioned herein is equivalent to the above-mentioned capacitance receiving layer 4.

A working principle of providing the expansion layer 8 can be seen according to the capacitance formula C=εS/4πkd.

In the capacitance formula, meanings of various parameters are as follows: C represents a capacitance of a capacitor, ε represents a dielectric constant of a dielectric, and different dielectrics, such as air, plastics, and ceramics, have different dielectric constants, the dielectric constant of air is close to 1, while some specific ceramic materials may have a relatively large dielectric constant, S represents a direct facing area of two capacitor plates, d represents a distance between two capacitor plates, where the smaller the distance, the larger the capacitance, and k is an electrostatic force constant, with a value of about 9.0×10⁹ N·m²/C².

It can be seen according to the above capacitance formula that as a distance between the metal filament 22 and the expansion layer 4 is very small, charges of the metal filament 22 are projected to the expansion layer 4 with almost no loss. When the expansion layer 4 is provided, the sensing area S is increased from an initial surface area of the metal filament 1 to the surface area of the metal filament 22 plus a surface area of the expansion layer 4, thus effectively increasing the sensing capacitance.

In addition, although the insulating layer is provided on the metal filament 4, the insulating layer may be undesirably damaged during processing and use, and electricity may conduct between the metal filament 22 and the expansion layer 4, so that electricity is conducted through the damaged metal filament 22, causing short circuit hazard. Since the expansion layer 4 is weakly conductive and has a very large square resistance, even if the insulating layer is damaged, a current across the metal filament 22 at a damaged portion will also be very small, and a heat generation amount will be very small, which can prevent occurrence of short circuit hazard when the insulating layer is damaged and occurrence of burning the sensing device.

Referring to what are shown in FIG. 13 and FIG. 19, optionally, a substrate 21 is provided on either side of the metal filament 22, where the substrate 21 is made from a micro conductive material, and the substrate 21 is the expansion layer 4. The substrate 21 mentioned herein is equivalent to the above-mentioned sheetlike substrate 21.

Optionally, the substrate 21 is provided on either side of the metal filament 22, where the substrate is made from a non-conductive material, and the expansion layer 4 is provided on a side of the metal filament 22 away from the substrate 21.

Optionally, referring to what is shown in FIG. 16, the metal filament 22 may be connected to the substrate 21 by means of sewing. As shown in FIG. 14, when the metal filament 22 is connected to the substrate 21 by means of sewing, a bonding layer 8 is provided on the side of the metal filament 22 away from the substrate 21, the bonding layer 8 is configured to bond a cushion body formed by the functional layer and the expansion layer 4 to other layers, and the bonding layer 8 is made from a conductive adhesive with weak conductivity, in which case, the bonding layer 8 is the expansion layer 4.

Optionally, the bonding layer 8 is a conductive adhesive with weak conductivity. During installation, release paper coated with the conductive adhesive with weak conductivity is selected, and after the release paper is peeled off, the conductive adhesive with weak conductivity is bonded to the side of the metal filament 22 away from the substrate 21.

Optionally, when the metal filament 22 is connected to the substrate 21 by means of sewing, in order to solve the problem of uneven appearance of the steering wheel after coating due to the sewing process of the metal filament 22, a flexible sheet which is optionally soft foam or fabric can also be added above the metal filament 22, where the soft foam or fabric, non-woven fabric, etc. are made from a micro conductive material.

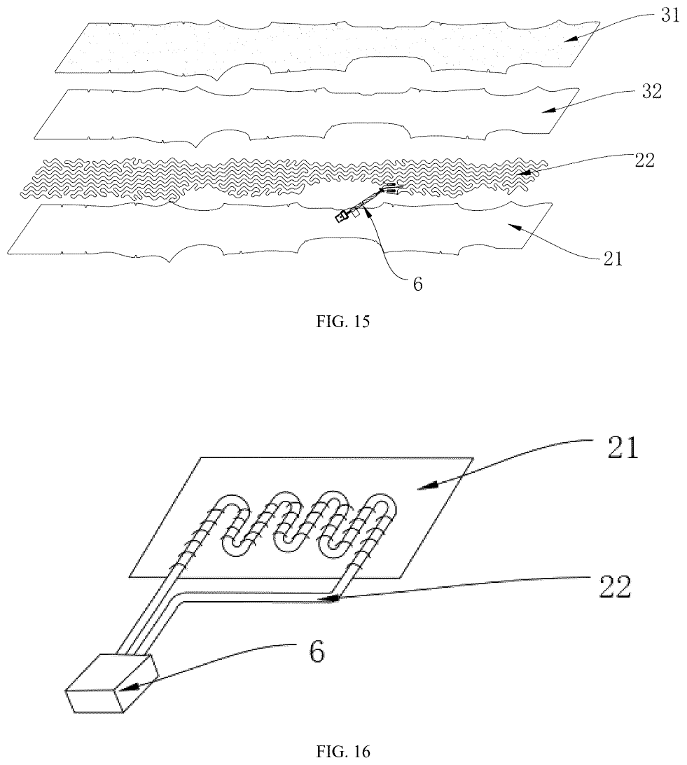

Referring to what is shown in FIG. 15, optionally, a first adhesive layer 32 having no conductivity is provided on the side of the metal filament 22 away from the substrate 21, and a covering layer 31 is provided on a side of the first adhesive layer 32 away from the metal filament 22, where the covering layer 31 is a flexible sheet made from a micro conductive material, in which case, the covering layer 31 is the expansion layer 4.

Optionally, the flexible sheet of the covering layer 31 is foam or fabric made from a micro conductive material.

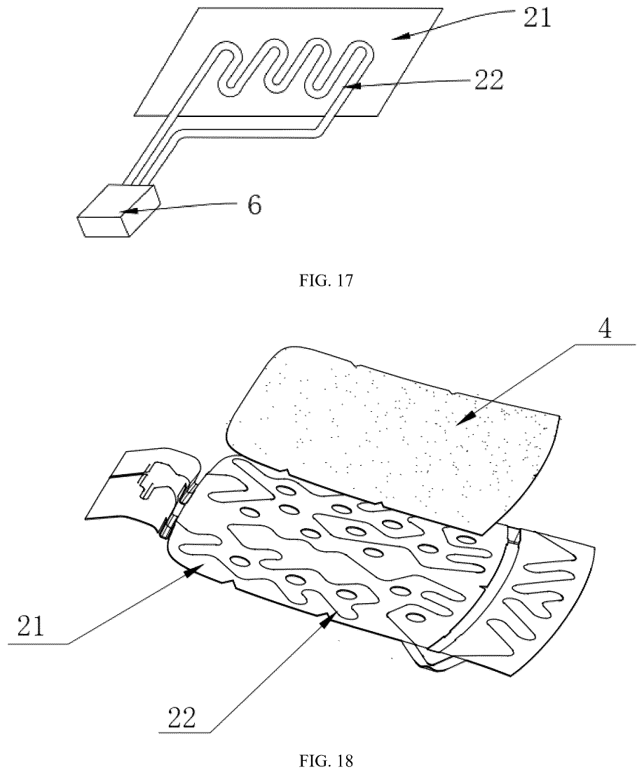

Optionally, referring to what is shown in FIG. 17, the metal filament 22 further can be connected to the substrate 21 by means of bonding. Optionally, the metal filament 22 is bonded onto the substrate 21 through a second adhesive layer, where the second adhesive layer adopts a conductive adhesive with weak conductivity, in which case, the second adhesive layer is the expansion layer 4.

Optionally, the micro conductive material is obtained by carburizing, printing, soaking in a conductive liquid, electroplating, or adding conductive fibers to woven fibers.

Optionally, the square resistance of the expansion layer 4 is between 10³Ω and 10⁶Ω.

Optionally, the sensing device further includes a skin 7, where the skin 7 is provided on the side of the metal filament 22 away from the substrate 21, the skin 7 is made from a micro conductive material, and the skin 7 is the expansion layer 4.

Optionally, each layer in the sensing device provided by the present disclosure can be used as the expansion layer, and forms of various layer structures other than the expansion layer can be combined with each other, which is not limited to several implementations exemplified in the above.

The present embodiment further provides a steering wheel with hand-off detection, where the steering wheel with hand-off detection includes a steering wheel body, and the sensing device with a charge receiving mapping layer as mentioned in the above is provided on a surface of the steering wheel body.

Optionally, the steering wheel body at least includes a steering wheel armature 9 provided at an innermost side (farthest from a side grasped by a human body) and a first foam layer 10 covering the outside of the steering wheel armature 9, and the sensing device with the charge receiving mapping layer as mentioned in the above is provided on a side of the first foam layer 10 away from the steering wheel armature 9.

Optionally, with reference to the steering wheel with hand-off detection as shown in FIG. 20, the expansion layer 4 of the steering wheel with hand-off detection is the substrate 21, the substrate 21 made from a micro conductive material is provided on a side of the metal filament 22 away from the body, and a second foam layer 11 is provided on a side of the substrate 21 away from the body, where the second foam layer 11 can be made using a secondary foaming process.

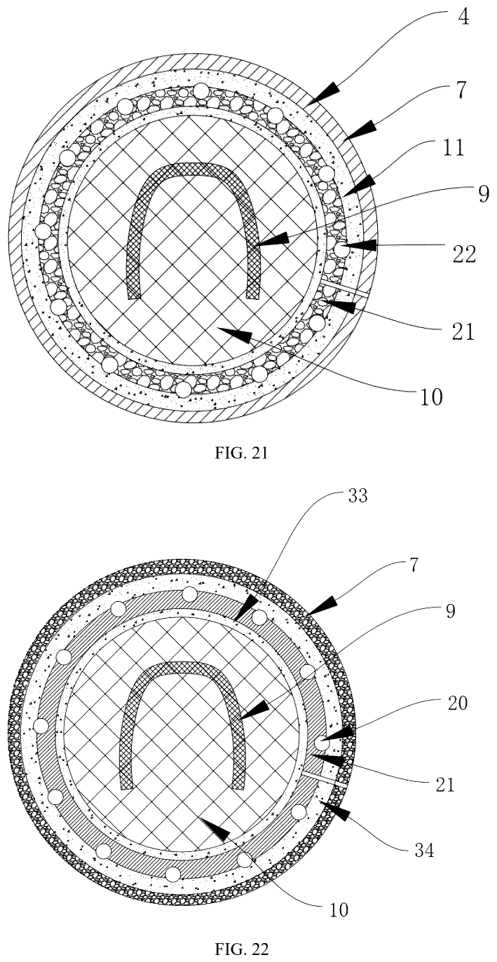

Reference is made to an embodiment of the steering wheel with hand-off detection as shown in FIG. 21. The expansion layer 4 of the steering wheel with hand-off detection is the skin 7 made from a micro conductive material. In this case, the substrate 21 is made from a non-conductive material, and the metal filament 22 is coiled on the substrate 21 to form the functional layer. A second foam layer 11 is provided on a side of the functional layer away from the first foam layer 10, where the second foam layer 11 can be prepared through a secondary foaming process.

With reference to the steering wheel with hand-off detection shown in FIG. 22, the expansion layer 4 of the steering wheel with hand-off detection is the substrate 21, in which case, a third adhesive layer 33 made from a non-conductive material is provided on a side of the first foam layer 10 away from the steering wheel armature 9, and the third adhesive layer 33 is configured to bond the expansion layer 4 onto the body. The substrate 21 is provided on a side of the third adhesive layer 33 away from the body, and the metal filament 22 is coiled on the substrate 21. A fourth adhesive layer 34 is further provided on a side of the substrate 21 away from the body, where the fourth adhesive layer 34 is configured to bond the skin 7 onto the substrate 21.

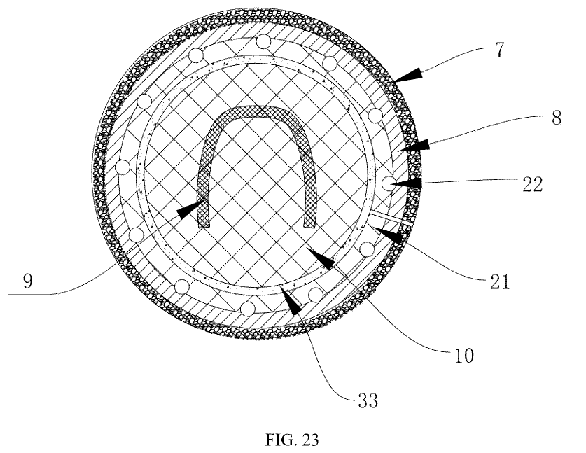

With reference to the steering wheel with hand-off detection as shown in FIG. 23, the expansion layer 4 of the steering wheel with hand-off detection is the bonding layer 8, in which case, the substrate 21 is made from a non-conductive material, the substrate 21 is bonded and wrapped on the steering wheel body through the third adhesive layer 33, the metal filament 22 is coiled on the substrate 21, the bonding layer 8 is provided on a side of the substrate 21 away from the third adhesive layer 33, the bonding layer 8 is configured to bond the skin 7 onto the substrate 21, and the skin 7 is made from a non-conductive material.

The principle and embodiments of the present disclosure are described herein with specific examples, and the description of the above embodiments is only intended to help understand the method of the present disclosure and a core idea thereof. The above-mentioned embodiments are merely preferable embodiments of the present disclosure. It should be noted that due to restriction of literal expressions, there are objectively infinite specific structures. For those of ordinary skill in the art, some improvements, modifications or variations could also be made without departing from the principle of the present disclosure, and the above technical features could also be combined in an appropriate manner. These improvements, modifications, variations or combinations, or direct application of the concept and technical solution of the disclosure to other occasions without improvements should be all considered as the scope of protection of the present disclosure.

### INDUSTRIAL APPLICABILITY

To sum up, the embodiments of the present disclosure provide a method for detecting a capacitance between an automotive interior component and a human body, a sensing device with a charge receiving mapping layer and a steering wheel with hand-off detection, which can improve the sensitivity of capacitance detection, so as to improve accuracy of determination.

1. A method for detecting a capacitance between an automotive interior component and a human body, comprising following steps:
S100, setting an occupancy capacitance threshold, a sampling period and a heating period;
S200, heating the automotive interior component through a metal wire in the heating period, wherein a human body occupancy sensor is provided in the automotive interior component, and a sheetlike substrate and the metal wire provided on the sheetlike substrate are provided in the human body occupancy sensor;
S300, acquiring a total human body occupancy capacitance through the human body occupancy sensor in the sampling period, wherein a capacitance receiving layer having conductivity is further provided in the automotive interior component, and the total human body occupancy capacitance is obtained through sensing capacitances between the human body and the metal wire, between the human body and the capacitance receiving layer and between the metal wire and the capacitance receiving layer;
S400, comparing magnitudes of the total human body occupancy capacitance and the occupancy capacitance threshold, so as to obtain a comparison result, wherein the comparison result comprises a first comparison result and a second comparison result, when the total human body occupancy capacitance is larger than or equal to the occupancy capacitance threshold, the first comparison result is obtained, and when the total human body occupancy capacitance is smaller than the occupancy capacitance threshold, the second comparison result is obtained, the first comparison result indicates that the automotive interior component is occupied, and the second comparison result indicates that the automotive interior component is unoccupied;
S500, executing step S200;
S600, updating the total human body occupancy capacitance, and executing steps S300-S400; and
S700, repeatedly executing steps S500-S600.

2. The method for detecting a capacitance between an automotive interior component and a human body according to claim 1, wherein the acquiring a total human body occupancy capacitance through the human body occupancy sensor in the sampling period comprises following steps:
S310, obtaining a single-sampling total capacitance according to a first sensing capacitance, a second sensing capacitance, and a third sensing capacitance, wherein the first sensing capacitance is a sensing capacitance between the human body and the metal wire, the second sensing capacitance is a sensing capacitance between the human body and the capacitance receiving layer, and the third sensing capacitance is a sensing capacitance between the metal wire and the capacitance receiving layer; and
S320, obtaining the total human body occupancy capacitance through a capacitance mean strategy.

3. The method for detecting a capacitance between an automotive interior component and a human body according to claim 1, wherein
the capacitance receiving layer is provided on a side of the metal wire away from the sheetlike substrate.

4. The method for detecting a capacitance between an automotive interior component and a human body according to claim 2, wherein the capacitance mean strategy comprises following steps:
S321, setting a number of single samplings;
S322, acquiring a total capacitance sequence, wherein the total capacitance sequence comprises a plurality of the single-sampling total capacitances, and a number of single-sampling total capacitances of the total capacitance sequence is the same as the number of the single samplings; and
S323, calculating an arithmetic mean of the total capacitance sequence, so as to obtain the total human body occupancy capacitance.

5. The method for detecting a capacitance between an automotive interior component and a human body according to claim 4, wherein the updating the total human body occupancy capacitance comprises following steps:
S610, removing a first single-sampling total capacitance in the total capacitance sequence, and adding the single-sampling total capacitance obtained in a next sampling period to an end of the total capacitance sequence, so as to obtain an updated total capacitance sequence;
S620, calculating an arithmetic mean of the updated total capacitance sequence, so as to obtain a next total human body occupancy capacitance, as a first total occupancy capacitance; and
S630, updating the total human body occupancy capacitance in step S300 as the first total occupancy capacitance.

6. The method for detecting a capacitance between an automotive interior component and a human body according to claim 4, wherein a product of a sum of the sampling period and the heating period and the number of single samplings is smaller than a preset detection duration, to realize that the comparison result can be obtained at least once within the preset detection duration.

7. The method for detecting a capacitance between an automotive interior component and a human body according to claim 1, wherein a duration of the heating period is 2.5 times or more of that of the sampling period.

8. The method for detecting a capacitance between an automotive interior component and a human body according to claim 1, wherein the capacitance receiving layer has weak conductivity.

9. The method for detecting a capacitance between an automotive interior component and a human body according to claim 1, wherein the capacitance receiving layer has strong conductivity, and a strong dielectric layer is present between the capacitance receiving layer and the metal wire.

10. A sensing device with a charge receiving mapping layer, comprising:
a functional layer, wherein the functional layer at least comprises a metal filament and an insulating layer, and the metal filament is configured to heat and sense; and
an expansion layer, wherein the expansion layer is provided on either side of the metal filament, and the expansion layer has weak conductivity, so as to receive charges mapped by the metal filament, and expand a sensing area.

11. The sensing device with a charge receiving mapping layer according to claim 10, wherein a substrate is provided on either side of the metal filament, wherein the substrate is made from a micro conductive material, and the substrate is the expansion layer.

12. The sensing device with a charge receiving mapping layer according to claim 10, wherein a substrate is provided on either side of the metal filament, wherein the substrate is made from a non-conductive material, and the expansion layer is provided on a side of the metal filament away from the substrate.

13. The sensing device with a charge receiving mapping layer according to claim 12, wherein a bonding layer is provided on the side of the metal filament away from the substrate, wherein the bonding layer is made from a conductive adhesive with weak conductivity, and the bonding layer is the expansion layer.

14. The sensing device with a charge receiving mapping layer according to claim 12, wherein a first adhesive layer is provided on the side of the metal filament away from the substrate, and a covering layer is provided on a side of the first adhesive layer away from the metal filament, wherein the covering layer is a flexible sheet made from a micro conductive material, and the covering layer is the expansion layer.

15. The sensing device with a charge receiving mapping layer according to claim 12, wherein the metal filament is bonded onto the substrate through a second adhesive layer, wherein the second adhesive layer adopts a conductive adhesive with weak conductivity, and the second adhesive layer is the expansion layer.

16. The sensing device with a charge receiving mapping layer according to claim 10, wherein a square resistance of the expansion layer is between 10³Ω and 10⁶Ω.

17. The sensing device with a charge receiving mapping layer according to claim 10, wherein the sensing device further comprises a skin, wherein the skin is provided on a side of the metal filament away from the substrate, the skin is made from a micro conductive material, and the skin is the expansion layer.

18. The sensing device with a charge receiving mapping layer according to claim 11, wherein the micro conductive material is obtained by carburizing, printing, soaking in a conductive liquid, electroplating, or adding conductive fibers to woven fibers.

19. A steering wheel with hand-off detection, wherein the steering wheel with hand-off detection comprises a steering wheel body, and a surface of the steering wheel body is provided with the sensing device with a charge receiving mapping layer according to claim 10.

20. The method for detecting a capacitance between an automotive interior component and a human body according to claim 1, wherein
the sheetlike substrate has weak electrical property, and the sheetlike substrate is used as the capacitance receiving layer.
